(19) United States
(12) Patent Application Publication
(10) Pub. No.: US 2025/0094872 A1
(43) Pub. Date: Mar. 20, 2025

(54) METHOD FOR PROVIDING TRAINING DATA FOR A MACHINE LEARNING (ML) MODEL FOR PREDICTING THE BEHAVIOR OF A TECHNICAL SYSTEM

(71) Applicant: Robert Bosch GmbH, Stuttgart (DE)

(72) Inventors: Christoph Zimmer, Stuttgart (DE); Erik Tonner, Mehring (DE); Karsten Frank, Sulzbach/Saar (DE); Markus Gorges, Gersheim (DE); Ricardo Juarez, Saarbruecken (DE)

(21) Appl. No.: 18/826,405

(22) Filed: Sep. 6, 2024

(30) Foreign Application Priority Data
Sep. 14, 2023 (DE) 10 2023 208 918.1

(51) Int. Cl. G06N 20/00

(52) U.S. Cl. CPC G06N 20/00

(57) ABSTRACT

A method for providing training data for a machine learning (ML) model for predicting the behavior of a technical system. The method includes: generating a first data set containing simulation data for the technical system; generating a second data set containing prototype data of the technical system; generating a third data set by combining the first and second data sets; training the ML model based on the third data set; generating a fourth data set as first input data based on the third data set by maximizing an information function, to obtain a first feature combination as input data for the technical system; measuring the first feature combination for the prototype data of the technical system to obtain a fifth data set; and adding the fifth data set as output data and the generated fourth data set as first input data to the third data set as training data.

### CROSS REFERENCE

The present application claims the benefit under 35 U.S.C. § 119 of German Patent Application No. DE 10 2023 208 918.1 filed on Sep. 14, 2024, which is expressly incorporated herein by reference in its entirety.

### FIELD

The present invention relates to a method for providing training data for a machine learning (ML) model for predicting the behavior of a technical system.

### BACKGROUND INFORMATION

Active learning is a conventional approach in the related art to efficiently train machine learning (ML) models, such as neural networks, with provided data. U.S. Patent Application Publication No. US 2023/177118 A1 describes such an approach for training an ML model by way of example.

The article by Cen-You Li et al. “Safe Active Learning for Multi-Output Gaussian Processes,” Bosch Center for Artificial Intelligence, Robert-Bosch-Campus 1, 71272 Renningen, Germany, also describes in detail the approach of active learning for multi-output processes.

To train an ML model on the basis of the conventional active learning approaches described above, simulation data are currently used in product development, in the prototype phase of a project, which simulation data are easy to generate without having to make large investments (e.g., sample parts).

These simulation data are used to support the development of the product, but are not always accurate enough to replace, for example, a later end-of-line test of the finished end product. This usually requires more accurate machine learning models, but their training requires a very large amount of data to bring these models to the required level or quality.

A major problem is that, in the prototype phase of product development, there is not enough data available to train a corresponding ML model, and the generation of additional data is associated with very high costs.

It is an object of the present invention to provide a solution by means of which efficient and cost-effective training data can be generated for a machine learning (ML) model, in order to efficiently predict the behavior of a technical system.

### SUMMARY

This object may be achieved by a method for providing training data for a machine learning (ML) model for predicting the behavior of a technical system according to features of the present invention.

According to a first aspect, the present invention relates to a method for providing training data for a machine learning (ML) model for predicting the behavior of a technical system.

According to an example embodiment of the present invention, in a first step, a first data set is generated, wherein this first data set contains simulation data for the technical system.

In a second step, a second data set is generated, wherein this second data set contains prototype data of the technical system.

In a third step, a third data set is generated by combining the first data set with the second data set.

In a fourth step, the ML model is trained on the basis of the third data set.

In a fifth step, a fourth data set is generated as first input data on the basis of the third data set by maximizing an information function, in order to obtain a first feature combination as input data for the technical system.

In a sixth step, the first feature combination is measured for the prototype data of the technical system, in order to obtain a fifth data set.

In a seventh step, the fifth data set as output data and the generated fourth data set as first input data are added to the third data set. This third data set is the training data for the ML model, which is provided in the course of the method.

In an eighth step, steps four to seven can optionally be repeated.

A fundamental concept of the present invention is that, on the basis of the active learning approach, information or data from the sample phase are correlated with data from the prototype phase. In this way, fewer data are needed from the prototype phase to generate appropriate training data to train an ML model to a defined level or to achieve a defined model quality.

Furthermore, the present invention is based on the following substantial aspects.

Data sets or measurements from the sample phase are used as a starting point for generating training data for training an ML model. Furthermore, one or more test systems from the prototype phase are available, but with few or no corresponding measurements or data sets or measurement data to date.

Within the meaning of the present invention, an initial multi-output model is trained, e.g. a multi-output Gaussian process, which predicts the outputs y_1 of the technical system from the sample phase and y_2 from the following phase (production phase) on the basis of input data x. For an x, there can be a measurement y_1 or y_2 or both.

A possible embodiment of the method of the present invention provides for a check to be carried out, after the fourth step of training the ML model, as to whether a termination criterion has already been met, and, if this termination criterion is met, a further step that terminates the method is carried out. In this way, the ML model can be trained efficiently, and the data effort required to provide the corresponding training data for the ML model is reduced or flexibly adapted to the required quality of the ML model to be trained.

A possible embodiment of the method of the present invention provides for the defined termination criterion to comprise at least one of the following criteria as to whether the ML model is trained further: maximum number of measurements carried out, a defined model quality of the ML model, number of iterations carried out to improve the ML model, a specified time period t for training the ML model. The advantage is thereby achieved that, depending on the requirements placed on the ML model to be trained, the method according to the present invention can be carried out efficiently and cost-effectively.

A possible embodiment of the method of the present invention provides for the checking step to be carried out using a validation data set, wherein the validation data set is used to generate verifiable quality information for the trained ML model, which information indicates how accurately the trained ML model maps the validation data set. The advantage is thereby achieved that, depending on the requirements placed on the ML model to be trained, the method according to the present invention can be carried out efficiently and cost-effectively.

A possible embodiment of the method of the present invention provides for the quality information of the ML model to indicate an error value of the ML model that the trained ML model makes when applying the validation data set, and if this output error value of the ML model is below a defined error tolerance limit, the training of the ML model is terminated. The advantage is thereby achieved that the method according to the present invention can be carried out efficiently and cost-effectively, depending on an application-specific requirement placed on the ML model to be trained.

According to a second aspect, the present invention relates to a computer program containing machine-readable instructions which, when executed on one or more computers and/or compute instances, cause the computer(s) or compute instance(s) to perform the method according to the present invention.

According to a third aspect, the present invention relates to a machine-readable data carrier and/or download product comprising the computer program.

According to a fourth aspect, the present invention relates to one or more computers and/or compute instances comprising the computer program and/or comprising the machine-readable data carrier and/or the download product.

Further measures improving the present invention are explained in more detail below, together with the description of the preferred exemplary embodiments of the present invention, with reference to the FIGURE.

### BRIEF DESCRIPTION OF THE DRAWING

FIG. 1 is a schematic flow diagram of the method 100 for providing training data 10 for a machine learning (ML) model 30 for predicting the behavior of a technical system 50, according to an example embodiment of the present invention.

### DETAILED DESCRIPTION OF EXAMPLE EMBODIMENTS

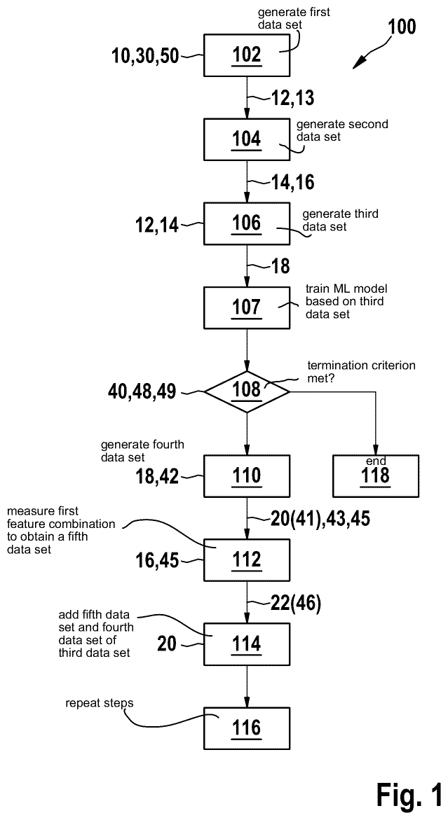

FIG. 1 is a schematic flow diagram of the method 100 for providing training data 10 for a machine learning (ML) model 30 for predicting the behavior of a technical system 50. A technical system 50 could be, for example, an injector, and the behavior would be the injection quantity. It could also be an EAC (=electrical air compressor), and the behavior to be modeled would be, for example, a pressure ratio in the compressor/turbine region.

The training data 10 can result from the data sets 12+14 or from the data sets 12+14+22 with a corresponding number of additional iterations.

In step 102, a first data set 12 is generated, wherein this first data set 12 contains simulation data 13 for the technical system 50.

In step 104, a second data set 14 is generated, wherein this second data set 14 contains prototype data 16 of the technical system 50.

In step 106, a third data set 18 is generated by combining the first data set 12 with the second data set 14.

In step 107, the ML model 30 is trained on the basis of the third data set 18.

In step 110, a fourth data set 20 is generated as first input data 41 on the basis of the third data set 18 by maximizing an information function 42, in order to obtain a first feature combination 45 as input data 43 for the technical system 50.

A possible example of an information function 42 could be a so-called “uncertainty” function. According to one aspect of the present invention, multiple possible input parameter combinations (e.g., 3 possibilities) are presented to the model.

The model then makes a prediction for each of these 3 combinations and outputs the information about the uncertainty prevailing in each of these combinations. The combination with the highest uncertainty is selected and is then physically measured and added to the training set.

With reference to an injector, the following example is given of a parameter combination of pressure and actuation duration:
Combination 1: P=1000 bar, AD=1000 μs. Model prediction: Injection quantity=200 mm³/I Uncertainty: ±0.3 mm³/I
Combination 2: P=1500 bar, AD=1200 μs. Model prediction: Injection quantity=250 mm³/I Uncertainty: ±0.5 mm³/I
Combination 3: P=2000 bar, AD=800 μs Model prediction: Injection quantity=270 mm³/I Uncertainty: ±1.3 mm³/I. This combination is checked (e.g., measured injection quantity=272.4 mm³/I), and the result is added to the training data.

The uncertainty can alternatively be given as an absolute value.

In step 112, the first feature combination 45 is measured 112 for the prototype data 16 of the technical system 50, in order to obtain a fifth data set 22.

In step 114, the fifth data set 22 as output data 46 and the generated fourth data set 20 as first input data 41 are added to the third data set 18. After step 114, it is possible to return to step 107.

In step 116, steps 107 to 112 are repeated. This step 116 is optional.

As also shown in FIG. 1, after the step 107 of training the ML model 30, a check 108 can optionally be carried out to determine whether a termination criterion 40 has already been met. If this termination criterion 40 is met, a step 118 that terminates the method 100 or ends the method 100 is carried out.

The defined termination criterion 40 can have at least one of the following criteria to decide whether the current ML model 30 is trained further: maximum number of measurements carried out, a defined model quality of the ML model 30, number of iterations carried out to improve the ML model 30, a specified time period t for training the ML model 30. Further criteria could be possible and are not limited to the examples mentioned.

The checking step 108 can preferably and optionally be carried out using a validation data set 48. By applying or using this validation data set 48, verifiable quality information 49 is generated for the trained ML model 30. This indicates how accurately the trained ML model 30 maps the validation data set 48. This means whether the outputs of the trained ML model 30 generated with the validation data set 48 are identical to the outputs generated by a simulation or measured outputs of this validation data set 48 or whether there are deviations therefrom. These deviations (actual state of the ML model 30) from a defined target state can preferably be treated accordingly as error information.

The quality information of the ML model 30 indicates an error value of the ML model 30 that the trained ML model 30 makes or generates when applying the validation data set 48. If this detected error value of the ML model 30 is below a defined error tolerance limit, the training of the ML model 30 or the further generation of training data 10 for the ML model 30 is terminated.

The corresponding sequence of the method 100 according to the present invention can also be described mathematically in a simplified form of an algorithm as follows:

| For i=1:N | |
|---|---|
| 1) | Select a new x_i = argmax Info(x) on the basis of an |
| | information measure for the multi-output GP |
| 2) | Measure the associated y_2 (e.g., with series parts). |
| 3) | Extend the data set by (x,y_2) |
| 4) | Update the multi-output model |

END

1), which corresponds to method step 110, is to be understood as the maximization of an information function as an information measure.
2) corresponds to method step 112.
3) corresponds to method step 114.
4) corresponds to method step 107, only not during the first run through of step 107.

The multi-output GP model can correlate data from the sample phase y_1 and y_2 and in the process transfer the knowledge from the sample phase. This advantageously makes it possible to correct the simulation results that are available for the entire characteristic map of a product and to achieve a good accuracy of the ML model to be trained without having to use a large amount of data for training the ML model. This allows the ML model to be trained cost-effectively and efficiently for a defined quality on the basis of the training data generated using the method according to the present invention.

What is claimed is:

1. A method for providing training data for a machine learning (ML) model for predicting behavior of a technical system, the method comprising the following steps:
generating a first data set, wherein the first data set contains simulation data for the technical system;
generating a second data set, wherein the second data set contains prototype data of the technical system;
generating a third data set by combining the first data set with the second data set;
training the ML model based on the third data set;
generating a fourth data set as first input data based on the third data set by maximizing an information function, to obtain a first feature combination as input data for the technical system;
measuring the first feature combination for the prototype data of the technical system, to obtain a fifth data set; and
adding the fifth data set as output data and the generated fourth data set as first input data to the third data set as training data for the ML model.

2. The method according to claim 1, wherein the measuring and adding steps of the method are repeated.

3. The method according to claim 1, wherein, after the training step, a check is carried out as to whether a termination criterion has already been met, and when the termination criterion is met, a step that terminates the method is carried out.

4. The method according to claim 3, wherein the defined termination criterion includes at least one of the following criteria as to whether the ML model is trained further: maximum number of measurements carried out, a defined model quality of the ML model, number of iterations carried out to improve the ML model, a specified time period for training the ML model.

5. The method according to claim 3, wherein the checking is carried out using a validation data set, wherein the validation data set is used to generate verifiable quality information for the trained ML model, which indicates how accurately the trained ML model maps the validation data set.

6. The method according to claim 5, wherein the quality information of the ML model indicates an error value of the ML model that the trained ML model makes when applying the validation data set, and when this output error value of the ML model is below a defined error tolerance limit, the training of the ML model is terminated.

7. A non-transitory machine-readable data carrier on which is stored a computer program including machine-readable instructions for providing training data for a machine learning (ML) model for predicting behavior of a technical system, the instructions, when executed by one or more computers and/or computer instances, cause the one or more computers and/or computer instances to perform the following steps:
generating a first data set, wherein the first data set contains simulation data for the technical system;
generating a second data set, wherein the second data set contains prototype data of the technical system;
generating a third data set by combining the first data set with the second data set;
training the ML model based on the third data set;
generating a fourth data set as first input data based on the third data set by maximizing an information function, to obtain a first feature combination as input data for the technical system;
measuring the first feature combination for the prototype data of the technical system, to obtain a fifth data set; and
adding the fifth data set as output data and the generated fourth data set as first input data to the third data set as training data for the ML model.

8. One or more computers and/or computer instances equipped by a non-transitory machine-readable data carrier on which is stored a computer program including machine-readable instructions for providing training data for a machine learning (ML) model for predicting behavior of a technical system, the instructions, when executed by the one or more computers and/or computer instances, cause the one or more computers and/or computer instances to perform the following steps:
generating a first data set, wherein the first data set contains simulation data for the technical system;
generating a second data set, wherein the second data set contains prototype data of the technical system;
generating a third data set by combining the first data set with the second data set;
training the ML model based on the third data set;
generating a fourth data set as first input data based on the third data set by maximizing an information function, to obtain a first feature combination as input data for the technical system;
measuring the first feature combination for the prototype data of the technical system, to obtain a fifth data set; and
adding the fifth data set as output data and the generated fourth data set as first input data to the third data set as training data for the ML model.
